(19) United States
(12) Patent Application Publication
(10) Pub. No.: US 2016/0042481 A1
(43) Pub. Date: Feb. 11, 2016

(54) Method and System for Digital Signing for Consent Using a Video Consent Signature and Cognitive Test

(71) Applicants: Shaun E. Williams, Monterey, CA (US); Javiera Franscisa Williams, Monterey, CA (US)

(72) Inventors: Shaun E. Williams, Monterey, CA (US); Javiera Franscisa Williams, Monterey, CA (US)

(21) Appl. No.: 14/732,389

(22) Filed: Jun. 5, 2015

Related U.S. Application Data
(60) Provisional application No. 62/008,991, filed on Jun. 6, 2014.

(51) Int. Cl. G06Q 50/18; G06Q 50/00

(52) U.S. Cl. CPC G06Q 50/18; G06Q 50/01

(57) ABSTRACT

Method and system for a consentee to obtain consent from a consenter. The consentee accesses a consentee profile having a primary photograph of the consentee to identify the consentee to the consenter. The consentee creates a new event record for obtaining and storing the consent from the consenter in a non-transitory computer readable medium. The consenter records a non-editable video of himself or herself for a predetermined length of time. A unique code is displayed on a screen viewable by the consenter during the recording step. The consenter is prompted to identify the unique code during the recording step to verify the consenter was alive and cognizant. A digital video consent signature is generated from the non-editable video; and the non-editable video and the digital video consent signature are stored in the new event record to be used as evidence to verify the consentee had consent from the consenter.

### PRIORITY CLAIM

This non-provisional application claims priority to Provisional Patent Application Ser. No. 62/008,991, entitled “A Method and System for Digital Signing for Consent using a Video Consent Signature and Cognitive Test”, filed on Jun. 6, 2014.

### TECHNICAL FIELD

The present invention relates to a method and system for a consentee to obtain consent from a consenter. More specifically, the present invention relates to a method and system for a consentee to obtain consent from a consenter using a digital video consent signature and a cognitive test of the consenter that is stored in a non-transitory computer readable medium to be used as evidence to verify the consentee had consent from the consenter.

### BACKGROUND OF THE INVENTION

Prior to this invention, there was generally nothing available that would allow an individual to record “consent” or an agreement to protect their interest such as their legal and/or pecuniary interest. The traditional method to record an agreement or consent is to maintain signed forms or complicated bio metrics systems. If these methods are not available, or the situation doesn't require that level of record, then an individual is left with a verbal agreement, which could ultimately lead to a situation where a statement and/or statements are contradicted. These contradictions can lead to costly attorney's fees, public trials, and undo stress.

A particular area where serious problems exist regarding consent is sexual assault cases. For instance, there are an exorbitant amount of sexual assault cases appearing in several different communities—ranging from inappropriate language to rape. There are many instances of serious cases being dismissed for lack of evidence and even false accusations being prosecuted. Many of these sexual assault cases have involved socially high profile celebrities who may have been falsely accused but they had no direct evidence to show that the sex encounter was consensual.

With the advances in today's technology, there are various ways to decrease sexual assault cases while also minimizing the stigma associated with the seriousness of this issue. However, nothing exits out there right now that utilizes the advances in technology, namely mobile phone technology such as smart phones, for decreasing sexual assault cases.

Based on the shortcomings in the prior art, there is definitely a need for an improved method of obtaining a record of “consent” for various events such as a consentee obtaining consent from a consenter to have consensual sex with the consentee. This need has led directly to the development of a method for recording consent by utilizing the video features of a mobile device, such as the iPhone, to generate a unique digital video consent signature.

### BRIEF SUMMARY OF THE INVENTION

One aspect of the present invention is to provide a method of using today's technology for establishing a record of an agreement and/or of consent by utilizing the video camera features of a mobile phone device such as an iPhone. This digital recording is meant to be an individual's proof of consent, and is the “signature” of the other party's agreement to a particular situation.

Another aspect of the present invention is to optionally provide a method for obtaining a digital record of consent related to a consentee obtaining consent from a consenter to have consensual sex with the consentee.

An additional aspect of the present invention is to optionally provide a digital video signature or the like for a consentee to obtain consent for a consenter to have consensual sex with the consentee which can be used in many different applications that requires only a ‘handshake’ in lieu of a verbal agreement. The consentees include such persons as socially high profile celebrities. The resulting digital video signature is used as evidence in venues such as a small claims court to a large scale trial with a jury.

A further aspect of the present invention includes a method for a consentee to obtain consent from a consenter, the method comprising the steps of accessing a consenter profile having a primary photograph of the consentee to identify the consentee to the consenter; showing the primary photograph to the consenter; creating a new event record for obtaining and storing the consent from the consenter in a non-transitory computer readable medium; recording a non-editable video of the consenter for a predetermined length of time; selecting and displaying a unique code for display on a screen viewable by the consenter during the recording step; prompting the consenter to identify the unique code during the recording; generating a digital video consent signature from the non-editable video; and storing the non-editable video and the digital video consent signature in the new event record.

An additional aspect of the present invention includes a system for a consentee to obtain consent from a consenter, the system comprising a mobile device having a photo of the consentee for identifying the consentee to the consenter; a non-transitory computer readable memory for storing a new event record; a camera coupled to the non-transitory computer readable memory for recording a non-editable video of the consenter for a predetermined length of time; a display for displaying a unique code during the recording of the non-editable video; prompting the consenter to identify the unique code during the recording the non-editable video; a computer processor for selecting the unique code; generating a digital video consent signature from the non-editable video; and associating the non-editable video and consent signature/code with the new event record in the non-transitory computer readable memory.

In a further aspect of the present invention, a non-transitory computer readable medium stores a computer program that when executed by at least one processor records consent given by a consenter for having consensual sex with a consentee, the computer program comprising a set of instructions for accessing a consentee profile having a photo of the consentee to identify the consentee to the consenter; a set of instructions for creating a new event for obtaining and storing consent from the consenter in a non-transitory computer readable medium; a set of instructions for recording a non-editable video of the consenter for a predetermined length of time; a set of instructions for selecting a unique code for display on a screen viewable by the consenter during the recording step; a set of instructions for displaying on a screen the unique code during the recording step; a set of instructions for prompting the consenter to identify the unique code during the recording; a set of instructions for generating a digital video consent signature from the non-editable video; and a set of instructions for storing the non-editable video and the digital video consent signature in a non-transitory computer readable medium.

Accordingly, for a better understanding of the invention, its functional advantages and the specific objects attained by its uses, reference should be made to the accompanying drawings, claims and descriptive matter in which there are illustrated embodiments of the invention.

### BRIEF DESCRIPTION OF THE DRAWINGS

FIG. 1(a) is one embodiment of the invention illustrating how a consentee can access and set-up a user/consentee profile.

FIG. 1(b) is one embodiment of the invention illustrating how a new event is created.

FIG. 1(c) is one embodiment of the invention illustrating how an event list is created.

FIG. 1(d) is one embodiment of the invention illustrating the settings of the invention.

FIG. 2 is one embodiment of the invention illustrating the splash screen and walkthrough menu.

FIGS. 3a, 3b and 3c are directed to one embodiment of the invention illustrating the login and sign up menu.

FIGS. 4a, 4b and 4c are directed to one embodiment of the invention illustrating the new event menu for the invention.

FIGS. 5a and 5b are directed to one embodiment of the invention illustrating the partner/consenter menu section of the invention.

FIGS. 6a, 6b and 6c are directed to one embodiment of the invention illustrating the settings menu.

FIG. 7 represents an execution diagram of the method for a consentee to obtain consent from a consenter.

FIG. 8 represents a detailed listing of the execution diagram of the method for a consentee to obtain consent from a consenter.

FIG. 9 illustrates a flow chart for a consentee to obtain consent from a consenter.

FIG. 10 illustrates a representative system that provides a suitable environment for some embodiments of the described systems and methods.

### DETAILED DESCRIPTION OF THE INVENTION

The following detailed description is of the best currently contemplated modes of carrying out the embodiments of the invention. The description is not to be taken in a limiting sense, but is made merely for the purpose of illustrating the general principles of the invention, since the scope of the invention is best defined by the appended claims.

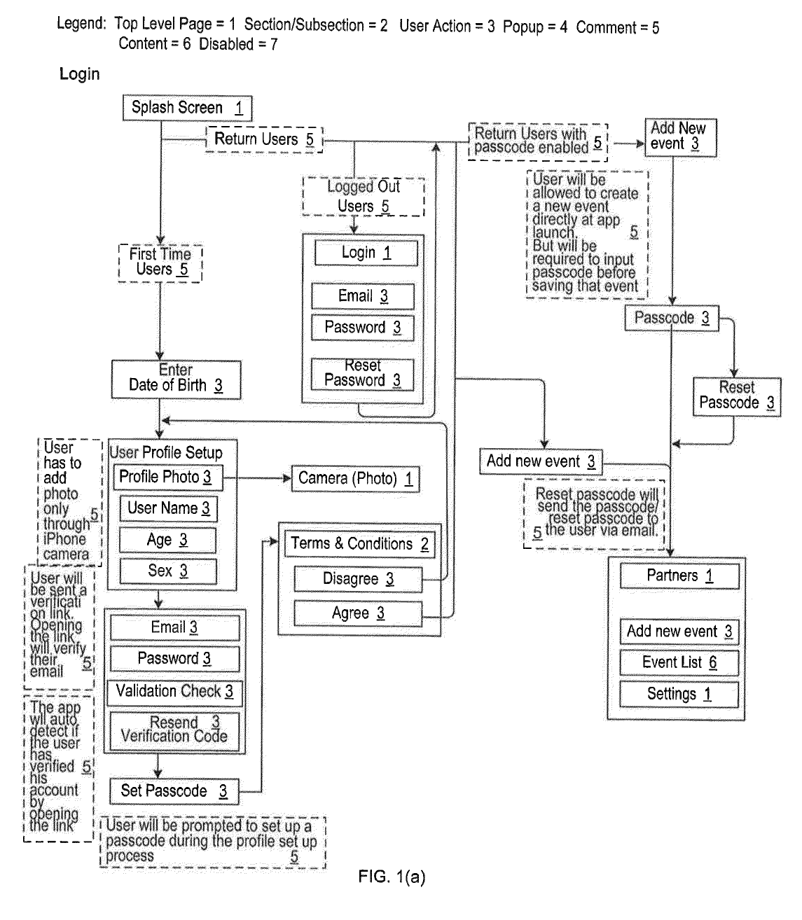

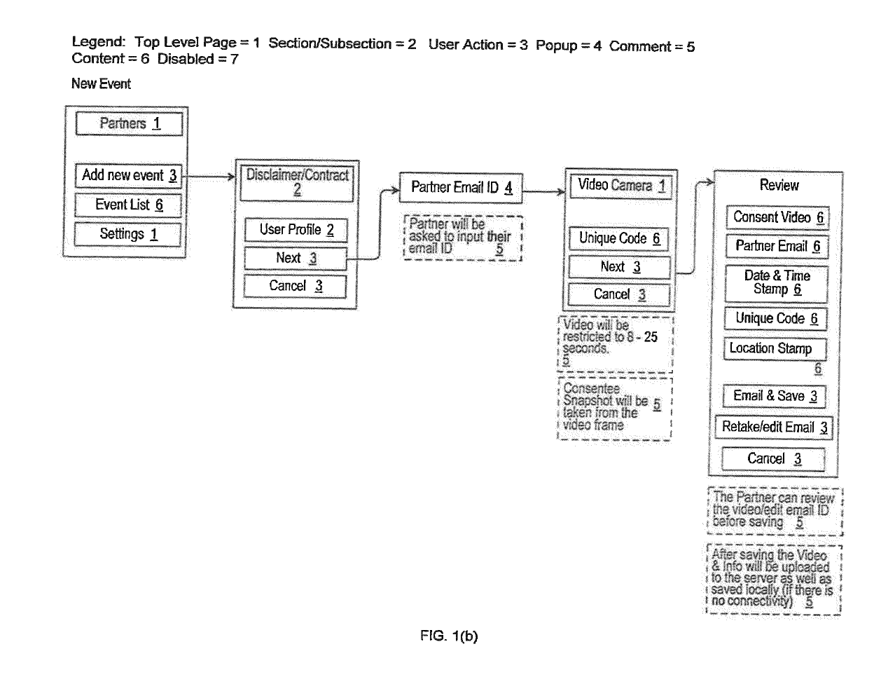

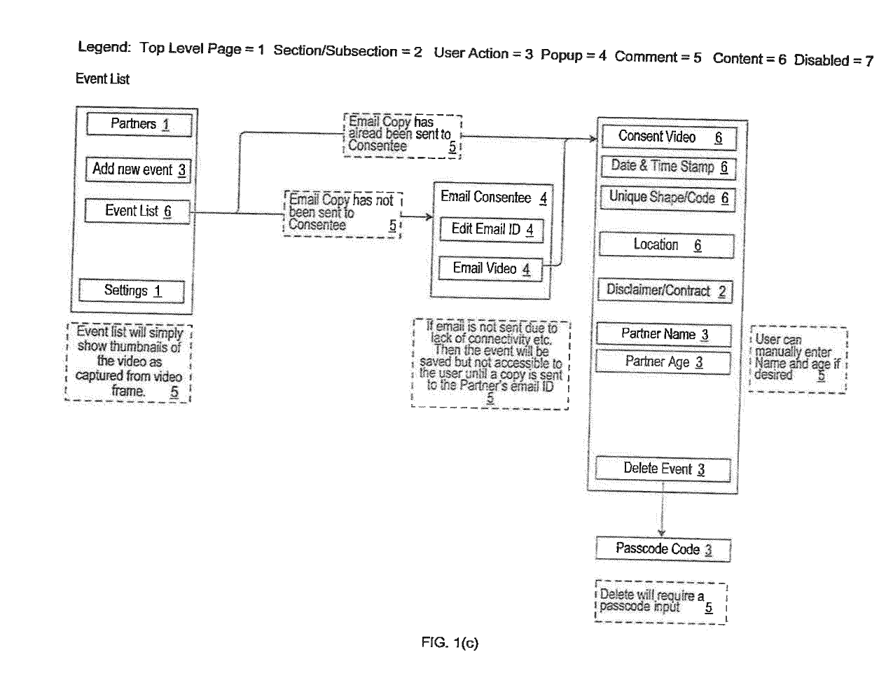

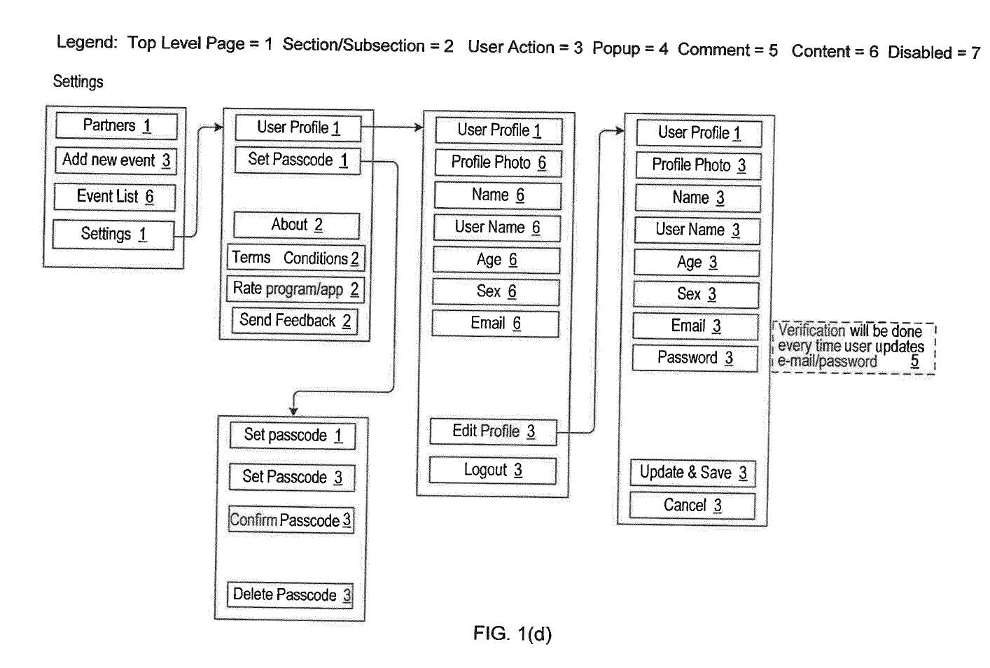

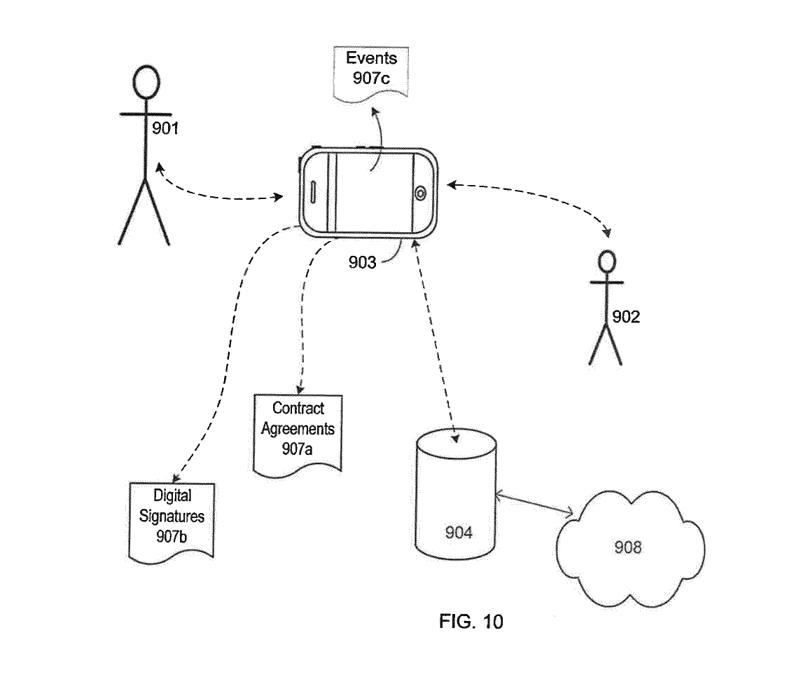

Referring now to FIGS. 1(a)-(d), one embodiment of the present invention provides a method and system for allowing two adult individuals to create a digital video signature 907b that memorializes an agreement 907a (See also FIG. 10). This method and system for generating a digital video signature 907b is also referred to as an “event” 907e which memorializes many types of agreements that are used as evidence. For instance, this digital video signature is used as evidence to verify that the consentee 901 had consent from the consenter 902 related to a specific event. The specific event to be verified could be related to, but not limited by, a consentee obtaining consent from a consenter to have consensual sex with the consentee.

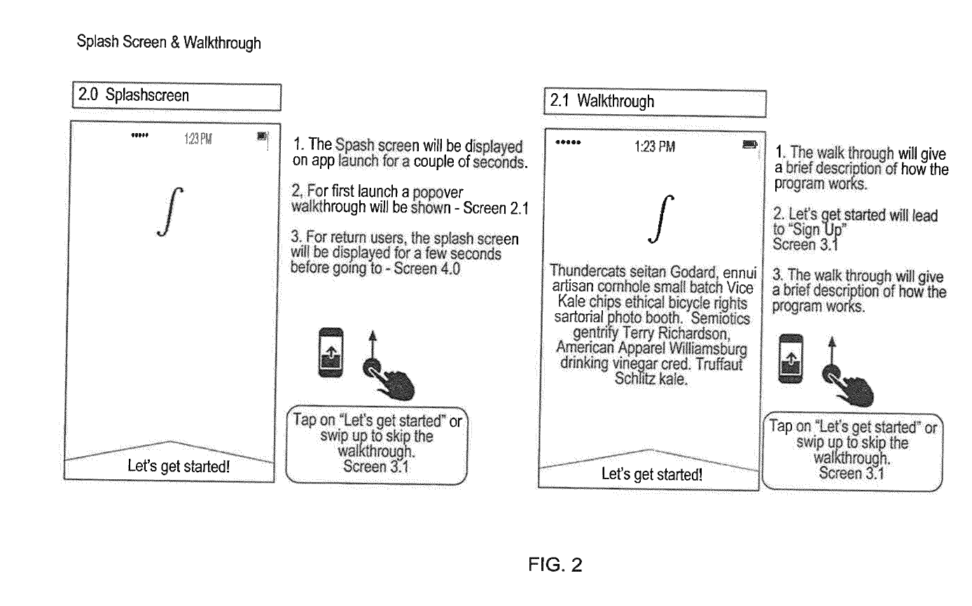

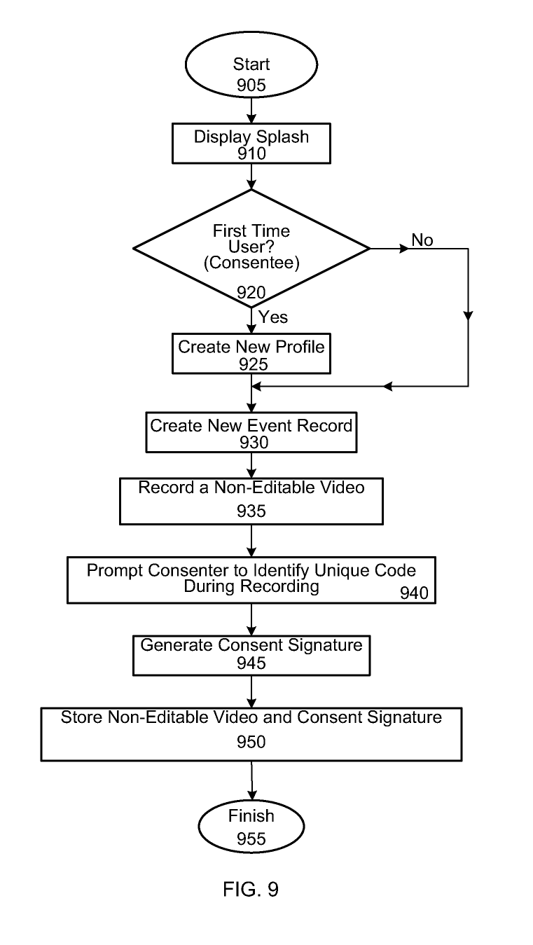

Referring now to FIG. 2, when a consentee first turns on the application, a splash screen will be displayed (See also 910 in FIG. 9). For return consentees, the splash screen is displayed for a few seconds before going to a new event. If the consentee is a “first time user”, he or she is led to the prompt “Sign Up”. A walkthrough menu will also be available for a consentee 901 to view which will give a brief description of how the invention works.

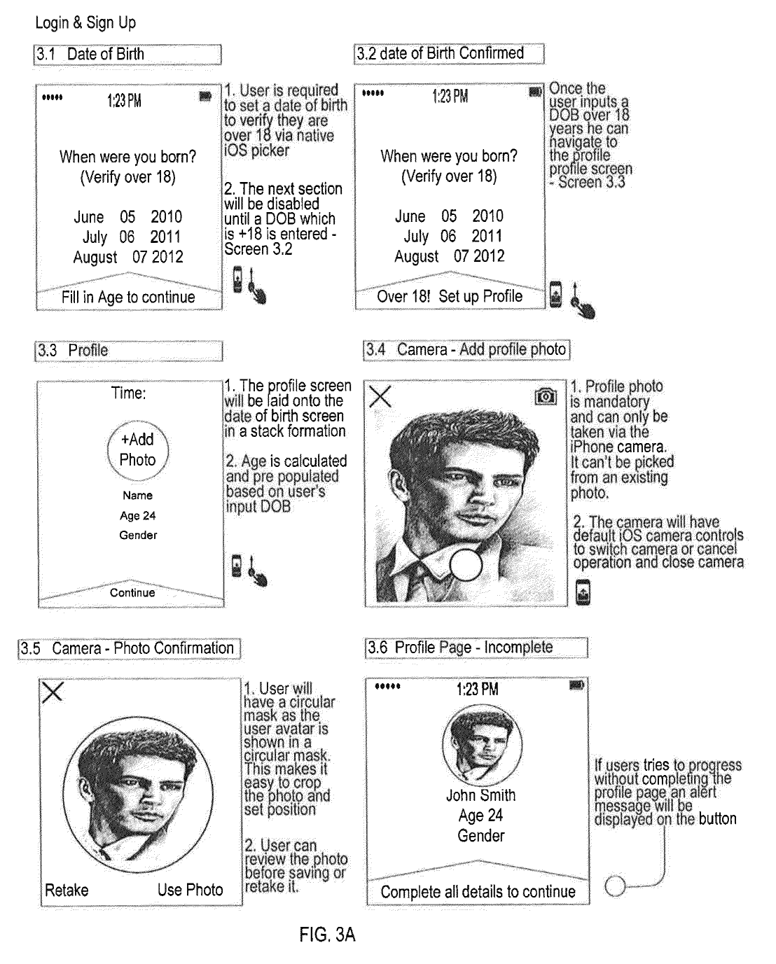

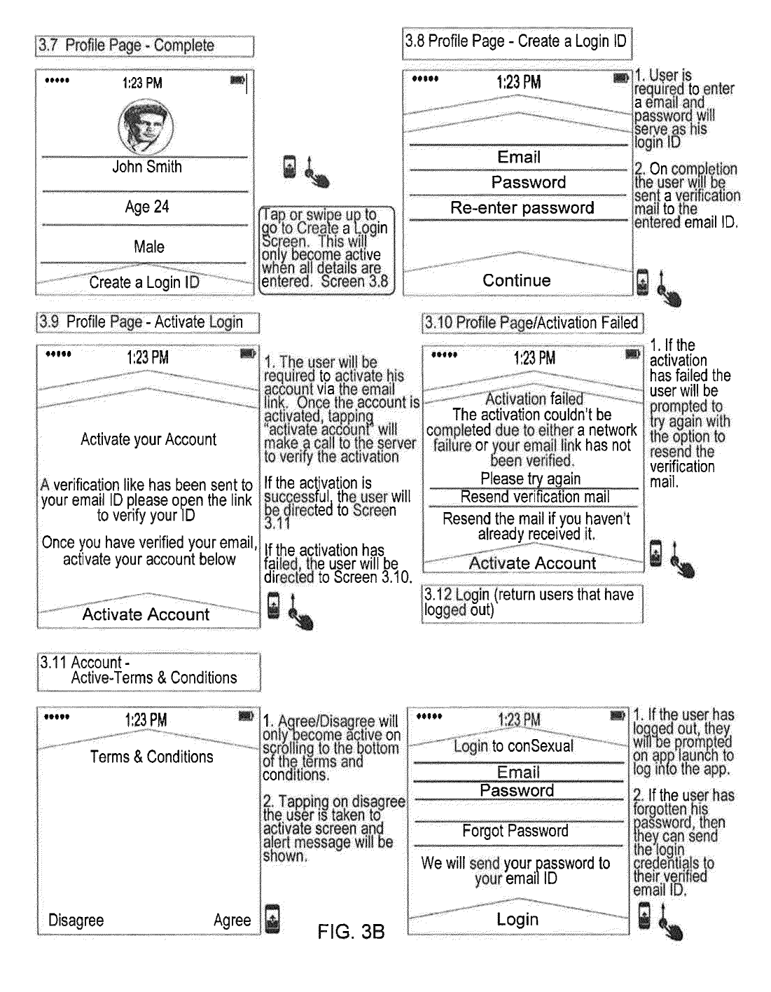

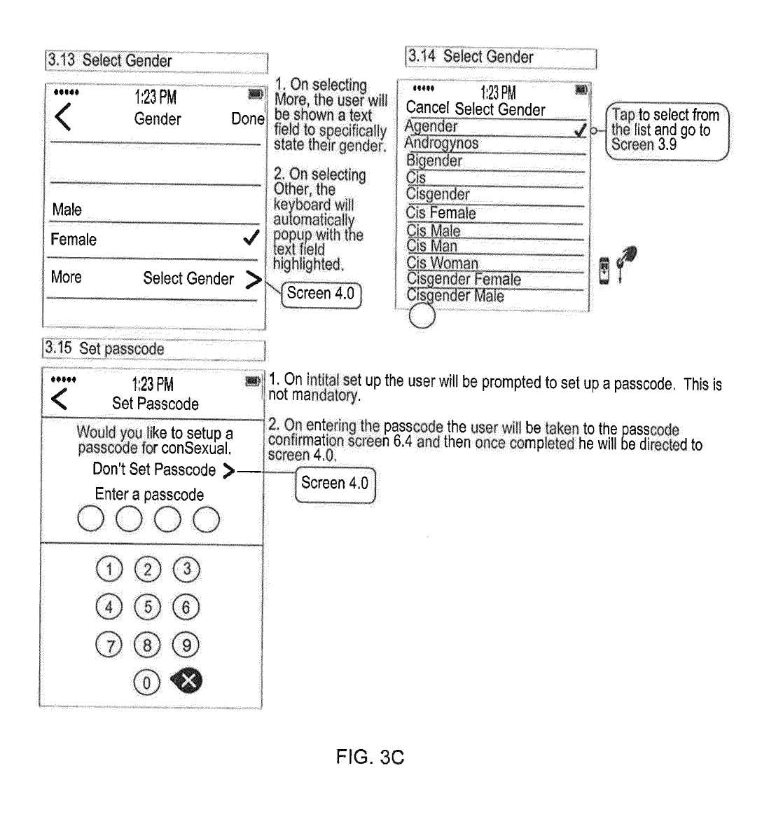

Referring now to FIGS. 3a-3c, one embodiment of the invention requires a first time user/consentee 901 to create a “consentee/user profile” (See also 910/920 in FIG. 9). While creating a profile, a user defines a profile that identifies themselves to any individual who could be a potential consenter (consenter is also referred to as a partner). The profile contains as much data that a developer determines is required to legitimize the authentication of a consentee profile. This data is locally generated and/or can be obtained from a third party source (e.g. Facebook, etc.). This profile is inserted into the contract portion that the consenter 902 reads and the consenter can expand that profile to obtain the consentee's data to confirm their identity.

Referring still to FIG. 3a-3c, a first time user (consentee) 901 is required to set a date of birth to verify that they are at least 18 years of age. Also, the consentee 901 is required to add a primary profile picture taken via the consentee's mobile phone camera such as one located on an iPhone 903. This photograph cannot be selected from an existing photograph. If a consentee 901 tries to progress without completing the profile page, an alert message is displayed indicating that all details have to be completed. One embodiment of the invention requires a consentee to read the terms and conditions associated with the application and then the consentee has a choice of agreeing or disagreeing to the terms and conditions. If the consentee 901 disagrees with the terms and conditions, he or she is directed back to the activate screen and an alert message is shown. The consentee's profile will only become active if he or she agrees to the terms and conditions associated with the application.

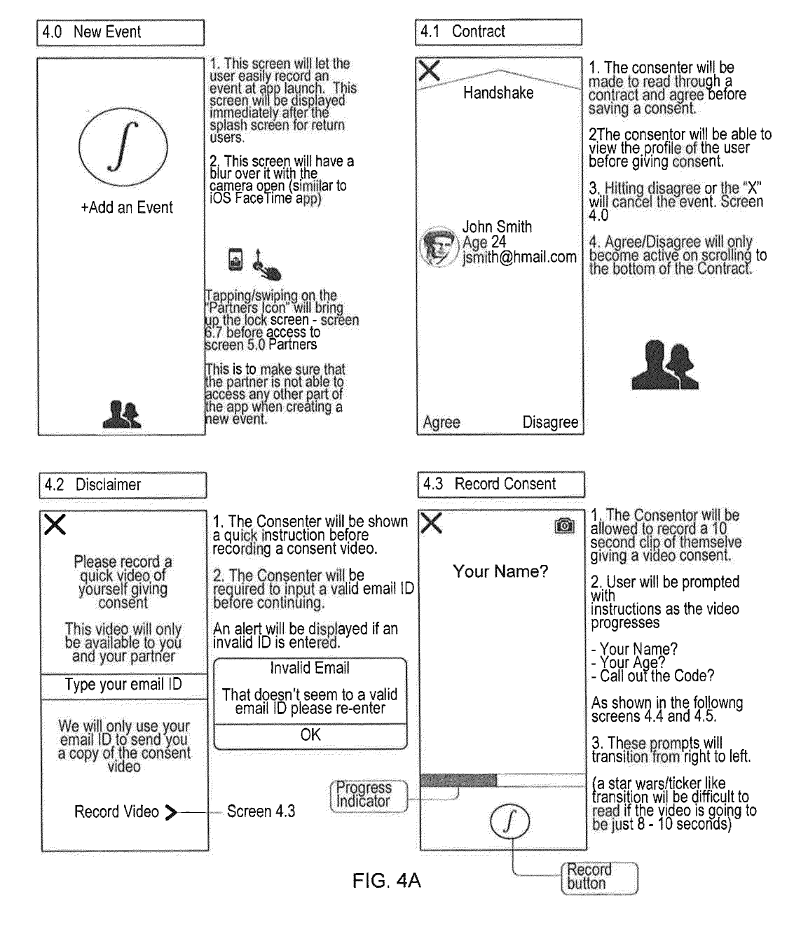

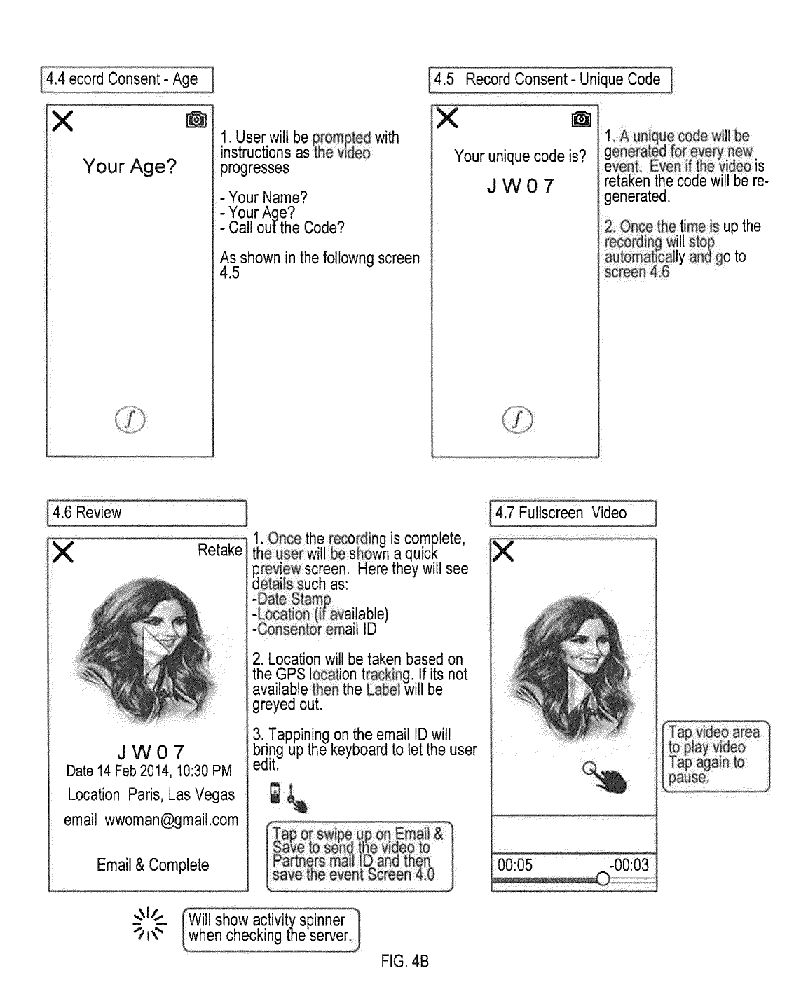

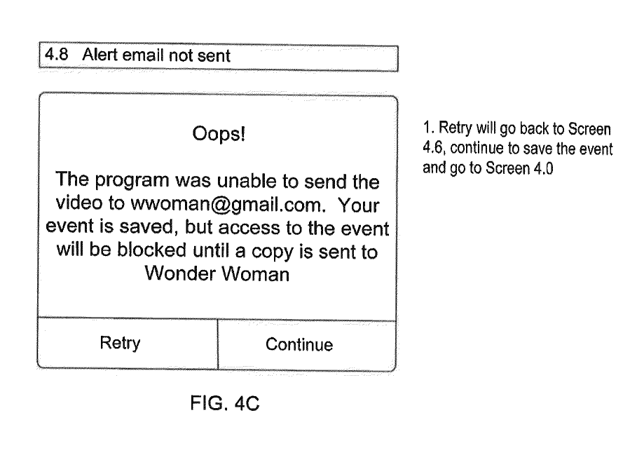

Referring now to FIGS. 4a-4c, the consentee 901 begins the application by selecting a new event for obtaining consent from the consenter (See also 930 in FIG. 9). This screen is displayed immediately after the splash screen for return users (consentees) who have properly created their consentee profile. (See also 930 in FIG. 9).

Referring still to FIGS. 4a-4c, a consenter is prompted to a screen that refers to the portion of the invention in which the method for obtaining consent is utilized in many different applications and only requires a ‘handshake’ in lieu of a verbal agreement. Moreover, an optional embodiment of the invention provides an application for allowing a consentee to obtain consent from a consenter to have consensual sex with the consentee. The resulting digital record of consent 907b is generated by video from a mobile device 903 that is used as evidence in such venues as small claims courts to large scale trials with juries (See also 945 in FIG. 9).

Referring still to FIGS. 4a-4c, when the consentee 901 and consenter 902 have discussed, understood, and agree to a situation for creating a digital video signature 907b to memorialize an agreement 907a between the consentee and the consenter, the consentee then gives his/her device 903 (containing the software) to the consenter 902. The consenter 902 will then he n a quick set of instructions before recording a consent video. The consenter will then read a disclaimer from the consentee's device 903 stating the framework of the contract 907a they are entering into. The consenter 902 has the option of agreeing to the contract and will be proceed to the next step if he/she agrees to the contract.

Referring further to FIGS. 4a-4c, the devices camera (interactive side) 903 will activate after the consenter agrees to the contract 907a and then a set of required informational statements will be displayed on the devices screen. One embodiment of the invention requires the consenter to record a video for a predetermined length of time on the consentee's mobile phone 903 and the recording time will be in the range of eight seconds to twenty-five seconds (See also 935 in FIG. 9). During the recording of the video, the consenter states three pieces of information. First, the consenter states their name. Second, the consenter states their age. Third, an additional embodiment of the invention requires the consenter to verbally identify a combination of symbols, shapes, numbers, and/or letters (See also 940 in FIG. 9). These three steps prove the consenter was alive, cognizant, and confirms their identity.

The digital video signature 907b generated is non-editable or very difficult to edit or to tamper with and is stored and marked with information from the user's mobile device 903 which includes location, time, date, giui, etc. (See also 945 in FIG. 9). Each individual digital signature 907b (per each application) is defined by as many of these parameters that a developer determines will legitimize the authentication of each event 907c. (See also 945 in FIG. 9). Further, the means for preventing or frustrating data tampering of the digital video signature 907b can be comprised of various methods. For example, the video digital signature 907b can be secured by data security technologies that include data encryption, strong authentication methods, secure memory, etc. (See also FIG. 4a-4c).

Referring even further to FIG. 4a-4c, one embodiment of the invention allows the consentee/user 901 to review the video before saving or retaking it. The terms “consentee” and “user” can be used interchangeably. The consentee 901 and consenter 902 are able to preview the entire contract 907a before saving the event 907c, and the entire contract 907a includes the consenter details. When the event 907c is saved by memorializing the agreement 907a between the consentee 901 and consenter 902, it will be stored on a mobile device 903 for future use as evidence for verifying that the consentee had consent from the consenter regarding a specific event 907c (See also 950/955 in FIG. 9). Optionally, one embodiment of the invention allows the events 907c, the agreements 907a between consentee, and consenter, and the digital video signatures 907b to be stored on servers 904 and/or on the internet 908. (See FIG. 10).

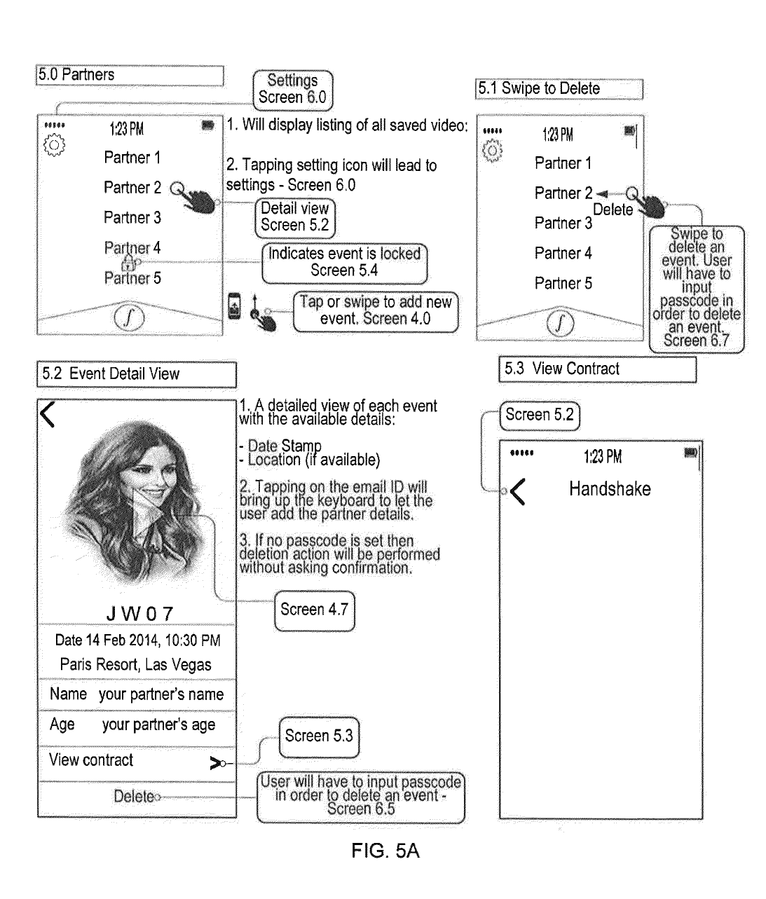

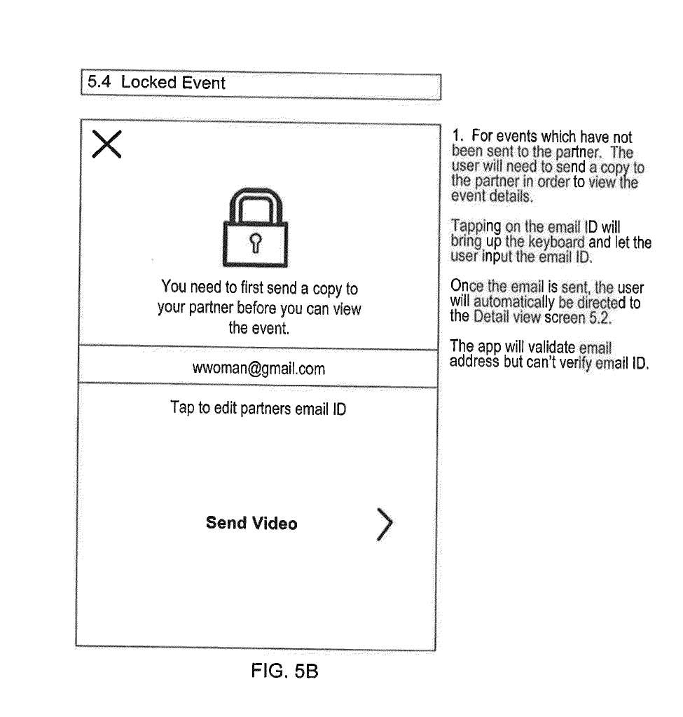

Referring now to FIGS. 5a-5b, another embodiment of the invention allows a consentee to view a listing of all saved events. Each event can be optionally displayed by showing a picture of the consenters/partners face or as a listing of each consenter such as consenter 1, consenter 2, consenter x, etc. The terms “partner” and “consenter” can be used interchangeably. Another screen prompt allows a consentee to search a specific event by name, date and time, or location. While viewing an event 907c, the consentee will not be able to edit or change any data associated with that event after it has been saved. In contrast, a consentee is able to delete an event, and a screen prompts the consentee to backup to email before deleting the event. An optional embodiment of the invention requires a consentee to send a copy of the event via email to a consenter before the consentee can view the event details. Once the consentee sends the event details to the consenter, the consentee will be automatically directed to the detail view screen.

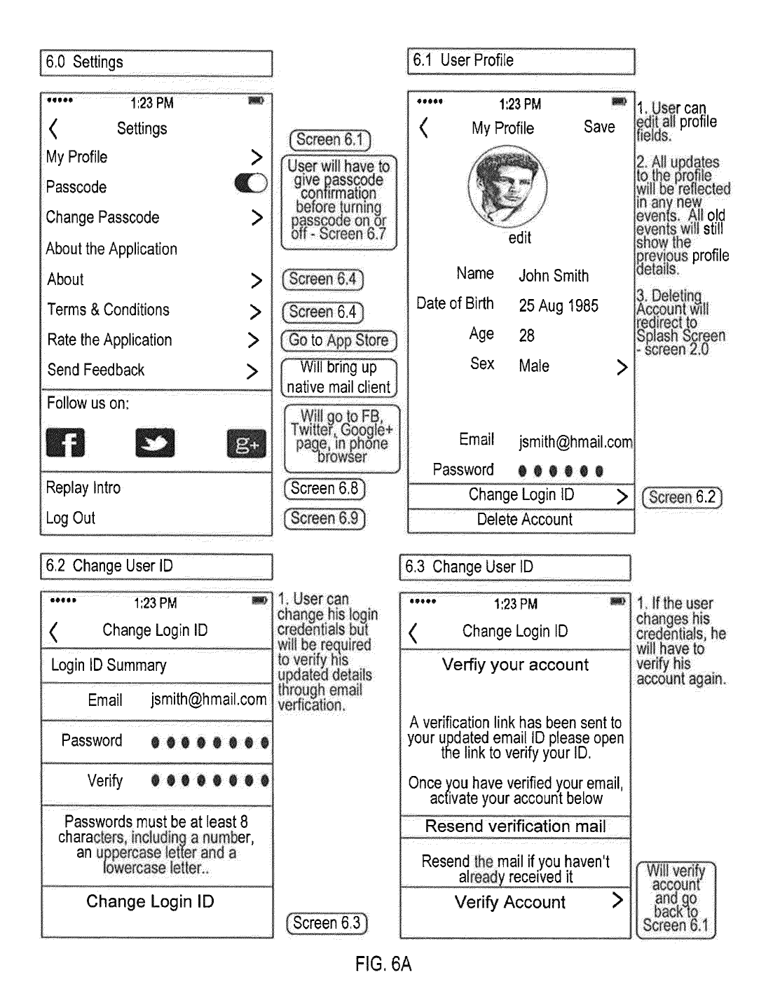

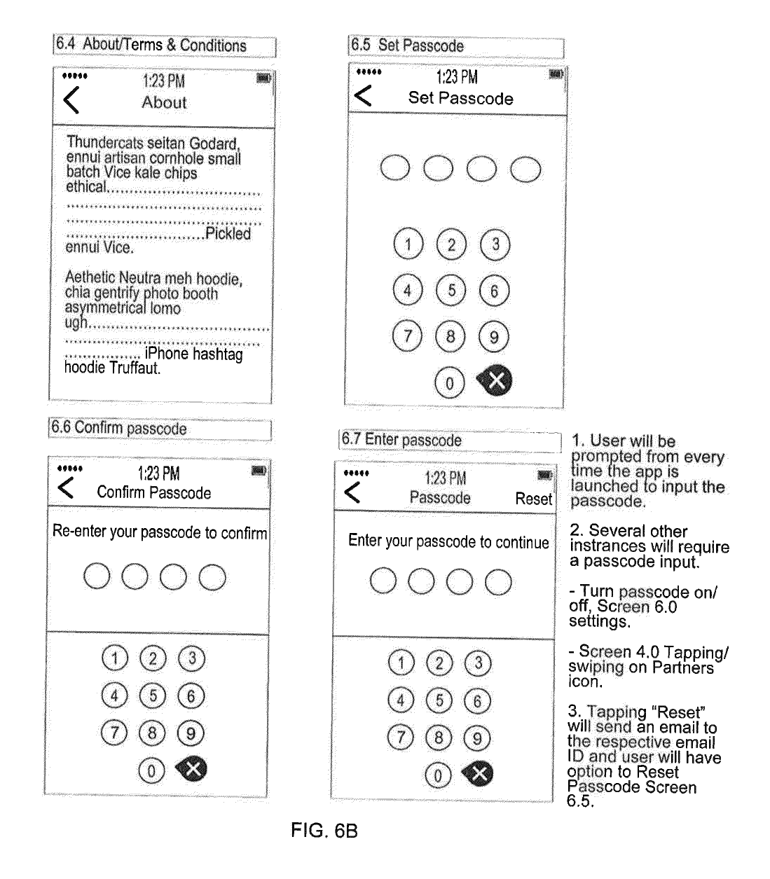

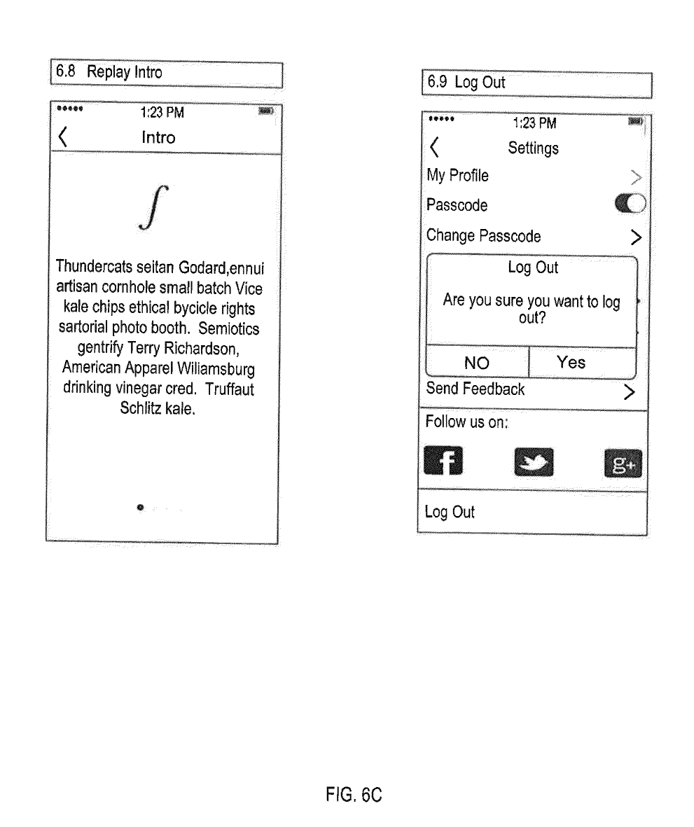

Referring now to FIGS. 6a6c, consentees are allowed to edit their profile field. For instance, consentees can change their phone number or email address and these changes will require reconfirmation via sms/email. All updates to the profile are reflected in any new events that are generated. All old events will still show the previous profile details of the consentee.

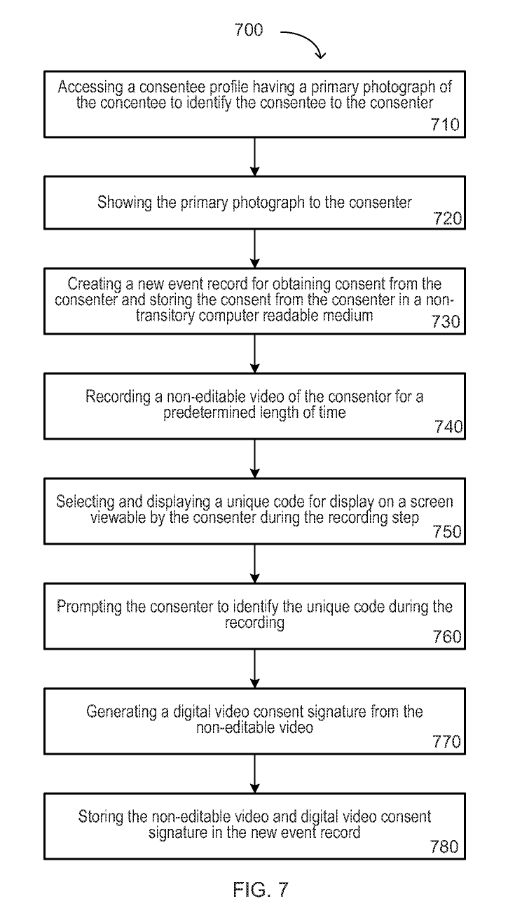

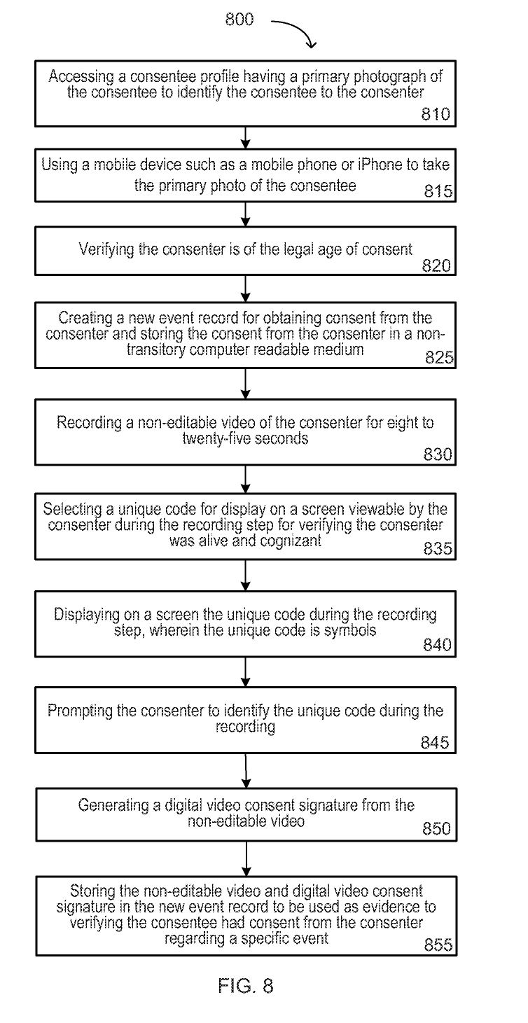

FIGS. 7 and 8 represent execution diagrams of the method for a consentee to obtain consent from a consenter. The method starts with the step of a user/consentee accessing a consentee profile (710/810). The consentee profile includes a photo of the consentee for identify the consentee to the consenter (710/810). Optionally, the consentee can be a socially high profile person such as a movie star, athlete or politician (710/810). A mobile device such as a mobile phone or an iPhone is used by the consentee to take a primary photo 815. The method is also configured to include the step of verify that a consenter is of the legal age to consent 820.

As further represented in FIGS. 7 and 8, the method is configured to include the step of creating a new event record for obtaining consent from the consenter (730/825). In another embodiment, the method allows for the consentee to optionally obtain consent from the consenter to have consensual sex 825. In a further embodiment, the invention includes the step of recording a non-edible video of the consenter for a predetermined length of time (740/830). During the recording step, the consenter is prompted to identify a unique code that is displayed on a screen (750/760/835/840/845). A digital consent signature is generated from the recorded non-editable video (770/850). The non-editable video and the digital video consent signature are stored in a non-transitory computer readable medium for use as evidence to verify the consentee had consent from the consenter regarding a specific event (780/855).

It should be understood that the foregoing relates to various embodiments of the invention and that modifications may be made without departing from the spirit and scope of the invention. It should also be understood that the present invention is not limited to the designs mentioned in this application and the equivalent designs in this description, but it is also intended to cover other equivalents now known to those skilled in the art, or those equivalents which may become known to those skilled in the art in the future.

What is claimed is:

1. A method for a consenter to obtain consent from a consenter, the method comprising the following steps:
accessing a consentee profile having a primary photograph of the consentee to identify the consentee to the consenter;
showing the primary photograph to the consenter;
creating a new event record for obtaining and storing the consent from the consenter in a non-transitory computer readable medium;
recording a non-editable video of the consenter for a predetermined length of time;
selecting and displaying a unique code for display on a screen viewable by the consenter during the recording step;
prompting the consenter to identify the unique code during the recording;
generating a digital video consent signature from the non-editable video; and
storing the non-editable video and the digital video consent signature in the new event record.

2. The method according to claim 1, wherein the step of identifying the unique code includes the step of prompting the consenter to verbally identify the unique code during the recording.

3. The method according to claim 1, wherein the step of creating a new event record includes the step of obtaining consent from the consenter for having consensual sex with the consentee.

4. The method according to claim 1 further including the step of verifying that the consenter is of the legal age to consent.

5. The method according to claim 1, wherein the step of prompting the consenter to identify the unique code during the recording step includes the step of verifying the consenter was alive and cognizant during the recording.

6. The method according to claim 3, wherein the step of storing the non-editable video and the digital consent signature in a non-transitory computer readable medium includes the step of providing evidence that verifies the consentee had consent from the consentee to have consensual sex with the consenter.

7. The method according to claim 6, wherein the consentee is a socially high profile person such as a movie star, athlete or politician.

8. The method according to claim 1, wherein the predetermined length of time for recording the non-editable video is between eight to twenty-five seconds.

9. The method according to claim 1, wherein the primary photo can only be taken on the consentee's mobile device.

10. The method according to claim 9, wherein the mobile device is a mobile phone.

11. The method according to claim 10, wherein the mobile phone is an iPhone.

12. The method according to claim 1, wherein the unique code is symbols.

13. A system for a consentee to obtain consent from a consenter, the system comprising:
a mobile device having a photo of the consentee for identifying the consentee to the consenter;
a non-transitory computer readable memory for storing a new event record;
a camera coupled to the non-transitory computer readable memory for recording a non-editable video of the consenter for a predetermined length of time;
a display for:
displaying a unique code during the recording of the non-editable video;
prompting the consenter to identify the unique code during the recording the non-editable video;
a computer processor for:
selecting the unique code;
generating a digital video consent signature from the non-editable video; and
associating the non-editable video and consent signature/code with the new event record in the non-transitory computer readable memory.

14. A non-transitory computer readable medium storing a computer program that when executed by at least one processor records consent given by a consenter for having consensual sex with a consentee, the computer program comprising:
a set of instructions for accessing a consentee profile having a photo of the consentee to identify the consentee to the consenter;
a set of instructions for creating a new event for obtaining and storing consent from the consenter in a non-transitory computer readable medium;
a set of instructions for recording a non-editable video of the consenter for a predetermined length of time;
a set of instructions for selecting a unique code for display on a screen viewable by the consenter during the recording step;
a set of instructions for displaying on a screen the unique code during the recording step;
a set of instructions for prompting the consenter to identify the unique code during the recording;
a set of instructions for generating a digital video consent signature from the non-editable video; and
a set of instructions for storing the non-editable video and the digital video consent signature in a non-transitory computer readable medium.

15. The computer program according to claim 14 further comprising a set of instructions for prompting the consenter to identify the unique code during the recording step to verify the consenter was alive and cognizant.

16. The computer program according o claim 14, wherein the predetermined length of time for recording the non-editable video is between eight to twenty-five seconds.

17. The computer program according to claim 14, wherein the primary photo can only be taken on the consentee's mobile device.

18. The computer program according to claim 17, wherein the mobile device is a mobile phone.

19. The computer program according to claim 18, wherein the mobile phone is an iPhone.

20. The computer program according to claim 19, wherein the unique code is symbols.
